(19) United States
(12) Patent Application Publication
(10) Pub. No.: US 2024/0295128 A1
(43) Pub. Date: Sep. 5, 2024

(54) COMPOSITE TILE STRUCTURE

(71) Applicant: JUU YUAN WOODEN MANUFACTURING CO., LTD., TAICHUNG CITY (TW)

(72) Inventors: CHENG YEN CHEN, TAICHUNG CITY (TW); YEN FANG LIN, TAICHUNG CITY (TW); CHIA HSIN CHEN, TAICHUNG CITY (TW); CHIA TE CHEN, TAICHUNG CITY (TW); CHUN PAO CHEN, TAICHUNG CITY (TW)

(21) Appl. No.: 18/662,477

(22) Filed: May 13, 2024

(30) Foreign Application Priority Data
Jan. 18, 2023 (TW) 112205932

(51) Int. Cl. E04F 15/02; B32B 3/06; B32B 9/00; B32B 9/04; E04F 13/08; E04F 15/08

(52) U.S. Cl. CPC E04F 15/02038; B32B 3/06; B32B 9/002; B32B 9/005; B32B 9/04; E04F 13/0866; E04F 13/0894; E04F 15/082; B32B 2419/04; E04F 2201/0107; E04F 2201/023; E04F 2201/043

(57) ABSTRACT

A composite tile structure for the rapid laying of multiple tiles on the floor or walls, and includes a surface layer, a substrate layer connected to a bottom of the surface layer, a connecting portion formed to one of two sides of the substrate layer, and an overlapping portion formed to another one of the two sides of the substrate layer. The overlapping portion corresponds in shape to the connecting portion. Multiple of the composite tiles can be assembled with each other by engaging the connecting portion of one tile with the overlapping portion of another composite tile.

### FIELD OF THE INVENTION

The present invention relates to tile structures, particularly to a composite tile structure for rapid construction.

### BACKGROUND OF THE INVENTION

In decoration, in order to maintain the beauty of the floor, durability, ease of cleaning, and functions such as moisture and water resistance, ceramic tiles or stone tiles is a practical tile material that is widely used in various indoor or outdoor spaces.

However, when laying traditional ceramic tiles, wet construction methods are typically employed, requiring skilled works to cooperate with on-site construction. However, in recent years, not only have skilled works become expensive and scarce in labor. Gaps between tiles, as small as 0.3 mm-05 mm, are noticeable, and this necessitates the use of tile levelers to adjust height differences. After drying, grouting is required to make the floor more even and aesthetically pleasing. The construction process of traditional ceramic tiles is tedious and complicated, thus there is a need for improvement.

The present invention intends to provide a composite tile structure to reduce costs and facilitate processing of a composite tile structure. The present invention also enhances durability, reduce noise, and provide insulation in a composite tile structure.

### SUMMARY OF THE INVENTION

The present invention relates to a composite tile structure and comprises a surface layer, a substrate layer connected to a bottom of the surface layer, a connecting portion formed to one of two sides of the substrate layer, and an overlapping portion formed to another one of the two sides of the substrate layer.

Preferably, the surface layer is ceramic tiles or stone.

Preferably, the substrate layer is wood, plastic, stone-plastic composite, wood-plastic composite, magnesium oxide board, fiberglass, or a combination thereof.

Preferably, the surface layer and the substrate layer are bonded by adhesive.

Preferably, the overlapping portion is an open groove. The connecting portion is a tenon, and the tenon is laterally engage with the open groove.

Preferably, a lateral recess is formed in an inner side of the overlapping portion. An inner ceiling of the open groove includes adjacent first vertical recesses and first vertical protrusions.

Preferably, the connecting portion includes a lateral protrusion, a second vertical protrusion, and a second vertical recess respectively located corresponding to the lateral recess, the first vertical recess, and the first vertical protrusion of the open groove.

Preferably, a soft foam layer or a hard foam layer is connected to a bottom of the substrate layer.

The present invention achieves the following effects:

By installing several composite tiles, the overlapping and connecting portions of the substrate layer interlock with each other, allowing the surface layers to fit together and form a solid unit. The use of composite materials facilitates the creation of holes for hanging hardware, thereby reducing processing and construction costs.

Through the design of the surface layer combined with the substrate layer, the present invention enhances the surface layer's resistance to bending, breaking, and deformation. Additionally, by incorporating a soft foam layer at the bottom of the substrate layer, it provides sound absorption and shock absorption effects. Alternatively, if a hard foam layer is installed at the bottom of the substrate layer, it can be utilized for efficient insulation purposes, suitable for rooftop and exterior wall applications.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view of the new composite tile structure of the present invention;

FIG. 2 is a plan view of the new composite tile structure of the present invention;

FIG. 3 illustrates action schematic of the connection of multiple tiles of the new composite tile structure of the present invention;

FIG. 4 is a perspective view to show the practical use of the new composite tile structure of the present invention, and

FIG. 5 shows another embodiment of the new composite tile structure of the present invention.

### DETAILED DESCRIPTION OF THE PREFERRED EMBODIMENT

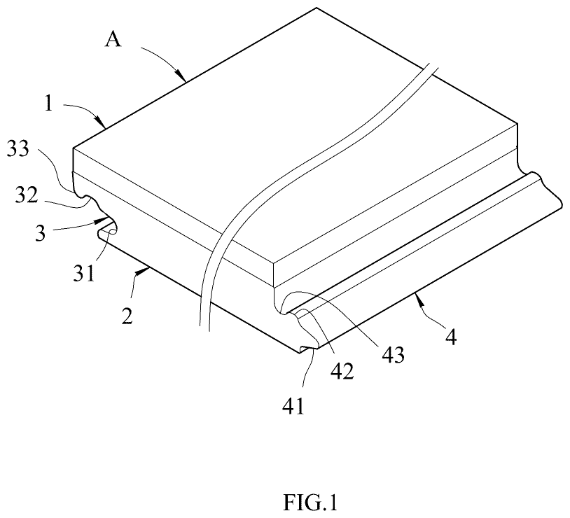

Referring to FIG. 1, the composite tile structure of the present invention primarily designed for the rapid laying of multiple composite tiles “A” on the floor or walls. The composite tile structure of the present invention comprises a surface layer 1, a substrate layer 2, an overlapping portion 3, and a connecting portion 4. The components mentioned above are illustrated with reference to the diagram below.

The surface layer 1, as shown in FIG. 1, can be ceramic tiles or stone, and it possesses functions such as wear resistance and waterproofing.

The substrate layer 2, as shown in FIG. 1, is bonded to the bottom of the surface layer 1 by adhesive. The substrate layer 2 can be made of wood, plastic, stone-plastic composite, wood-plastic composite, fiberglass, or a combination thereof.

The overlapping portion 3 is shaped corresponding to a shape of the connecting portion 4. The overlapping portion 3 is an open groove, and the connecting portion 4 is a tenon. The tenon is laterally engage with the open groove. A lateral recess 31 is formed in an inner side of the overlapping portion 3. An inner ceiling of the open groove includes adjacent first vertical recesses 32 and first vertical protrusions 33.

The connecting portion 4 includes a lateral protrusion 41, a second vertical protrusion 42, and a second vertical recess 43 respectively located corresponding to the lateral recess 31, the first vertical recess 32, and the first vertical protrusion 33 of the open groove.

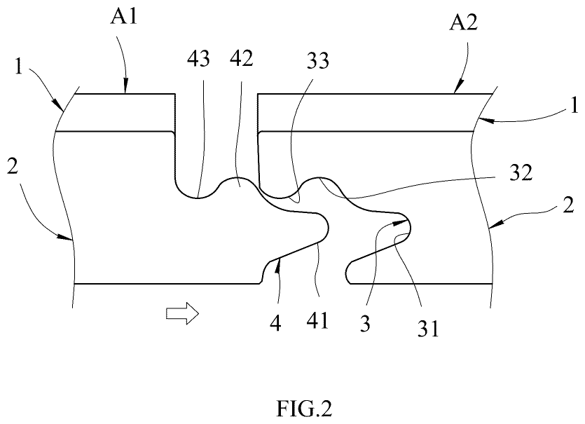

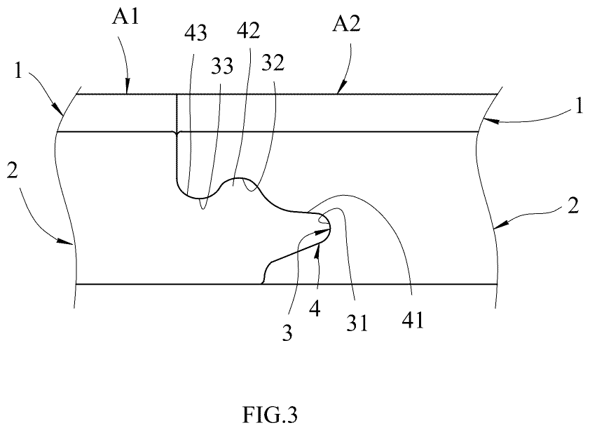

Please refer to FIGS. 2 and 3, multiple composite tiles “A1”, “A2” are arranged on the ground using dry construction methods, this arrangement allows wood tile installers to work on these composite tiles “A1”, “A2”. By this way, the present invention is no longer restricted to skilled workers, thereby improving the labor shortage issue.

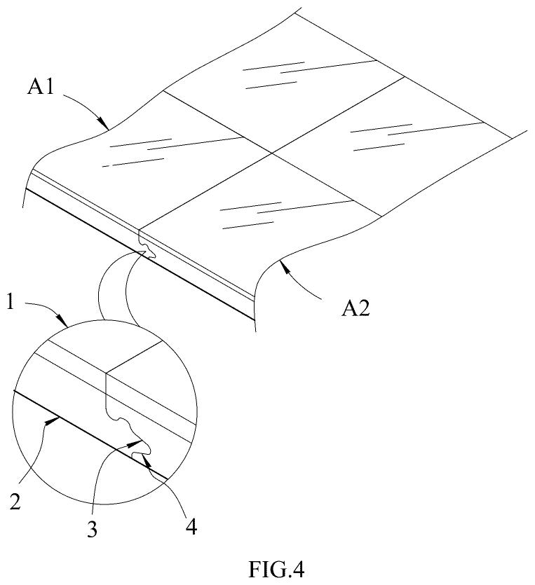

Furthermore, please refer to FIGS. 3 and 4, the installer aligns the connecting portion 4 of the several composite tiles “A1” with the overlapping portion 3 of the several composite tiles “A2” and pushes them together. The lateral protrusion 41 of the connecting portion 4 is inserted into the lateral recess 31 of the overlapping portion 3 to secure them, while the first vertical recess 32 is engaged with the second vertical protrusion 42, and the first vertical protrusion 33 is engaged with the second vertical recess 43. Additionally, the overlapping portion 3 is designed as an open groove, while the connecting portion 4 is designed as a tenon, allowing the tenon to fit into the groove. This mortise and tenon method enables easy assembly with high precision, with height differences less than 0.1 mm, reducing the need for tile levelers. Furthermore, these composite tiles “A1”, “A2” have excellent processability, allowing for the creation of holes for hanging hardware on their surface without risking damage to the entire surface layer.

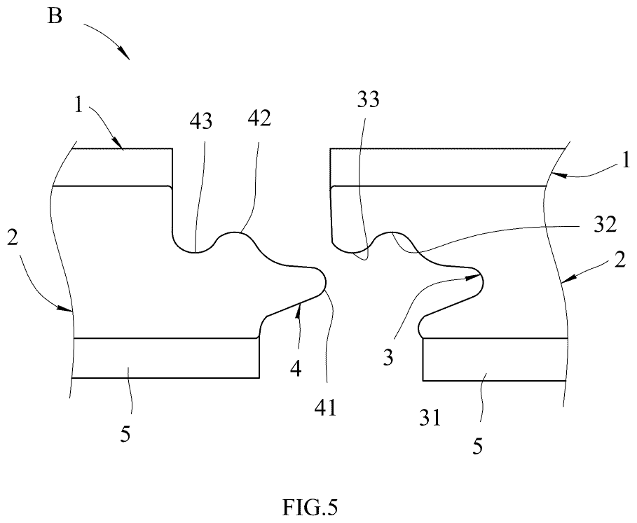

FIG. 5 illustrates another embodiment of the present invention, wherein multiple composite tiles “B” are additionally equipped with a soft foam layer 5 or a hard foam layer attached to the bottom of the substrate layer 2. The soft foam layer 5 can absorb a certain amount of noise, easily achieving −18 db˜−25 db, meeting the building regulations requirements in various countries worldwide. Additionally, when the substrate layer 2 is affixed with a hard foam layer of 10 mm or more, it can act as insulation material, suitable for rooftops, exterior walls, or related dry-hanging tile construction, offering significant insulation benefits.

While we have shown and described the embodiment in accordance with the present invention, it should be clear to those skilled in the art that further embodiments may be made without departing from the scope of the present invention.

What is claimed is:

1. A composite tile structure comprising:
a surface layer;
a substrate layer connected to a bottom of the surface layer;
a connecting portion formed to one of two sides of the substrate layer; and
an overlapping portion formed to another one of the two sides of the substrate layer, the overlapping portion being shaped corresponding to a shape of the connecting portion.

2. The composite tile structure as claimed claim 1, wherein the surface layer is ceramic tiles or stone.

3. The composite tile structure as claimed claim 1, wherein the substrate layer is wood, plastic, stone-plastic composite, wood-plastic composite, magnesium oxide board, fiberglass, or a combination thereof.

4. The composite tile structure as claimed claim 2, wherein the surface layer and the substrate layer are bonded by adhesive.

5. The composite tile structure as claimed claim 4, wherein the overlapping portion is an open groove, the connecting portion is a tenon, the tenon is laterally engage with the open groove.

6. The composite tile structure as claimed claim 5, wherein a lateral recess is formed in an inner side of the overlapping portion, an inner ceiling of the open groove includes adjacent first vertical recesses and first vertical protrusions.

7. The composite tile structure as claimed claim 6, wherein the connecting portion includes a lateral protrusion, a second vertical protrusion, and a second vertical recess respectively located corresponding to the lateral recess, the first vertical recess, and the first vertical protrusion of the open groove.

8. The composite tile structure as claimed claim 1, further comprising a soft foam layer or a hard foam layer connected to a bottom of the substrate layer.
